(19) United States
(12) Patent Application Publication
(10) Pub. No.: US 2007/0192982 A1
(43) Pub. Date: Aug. 23, 2007

(54) Trowel

(76) Inventor: Ching-Yi Ho, Shenkang Hsiang (TW)

Correspondence Address: CHARLES E. BAXLEY, ESQ., 90 JOHN STREET, THIRD FLOOR, NEW YORK, NY, 10038, US

(21) Appl. No.: 11/361,167

(22) Filed: Feb. 23, 2006

(51) Int. Cl. B05C 17/10

(52) U.S. Cl. 15/235.8; 15/144.1; 15/235.4

(57) ABSTRACT

A trowel comprises a handle, which is combined with a tongue that is further combined with a blade. Said handle and tongue are connected through a pivot structure such that the handle can pivot thereon and be positioned at a desired position. Further, a blade-fixing structure allows said tongue and blade to be combined or separated with each other.

### BACKGROUND OF THE INVENTION

1. Field of the Invention

The present invention relates to hand tools and, more particularly, to an improved construction of a trowel.

2. Description of Related Art

Referring to FIG. 1, a conventional trowel typically consists of a handle fastened on a float.

As the float and handle are integrated firmly, there is one of the disadvantages of a conventional trowel that the handle is unrotatable and there is another disadvantage that the float is not replaceable.

An unrotatable handle is typically fixed on the float in the direction parallel to the axis of the float. Once a user intends to change the operating angle and direction, it is necessary for the user to change the holding gesture to accommodate the trowel to the working surface. In consequence, an inappropriate holding gesture may not only reduce the efficiency of work but also result relatively deteriorated resultant surface. It may even cause occupational injury to the user for such an inappropriate holding gestures lasting long term.

Further it would be inconvenient for a user to prepare and carry various trowels while the float is unreplaceable. Meantime, the handles of each trowel occupy relatively larger space than only one handle.

### SUMMARY OF THE INVENTION

To improve current trowels, the inventor of present invention has provided a specific solution involved a trowel with a rotatable handle and a replaceable float.

A trowel comprises a handle, a blade and a tongue therebetween. The handle is connected with the tongue by a pivot structure such that it is capable of rotating around a pivot shaft and can be orientated in a desired position thereon. The tongue is further connected to the blade through a fixing structure, which allows the tongue and blade to be combined or separated with each other.

It is one object of the present invention to provide a trowel with a rotatable handle that can be positioned in any desired direction around said pivot structure such that a user can operate the trowel at will and keeps comfortable holding gesture without respect to different working surfaces.

It is another object of the present invention to provide a trowel, in which the float can be replaced to meet operational needs.

It is still another object of the present invention to provide a trowel in which the handle is ergonomically designed to provide improved comfortability and stability for handling.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a perspective view of a prior-art trowel;

FIG. 2 is an exploded view of a trowel according to the present invention;

FIG. 3 is a perspective view of a trowel according to the present invention:

FIG. 4 is a sectional view taken along line 4-4 of FIG. 3;

FIG. 5 is a sectional view taken in an enlarged scale along line 5-5 of FIG.4;

FIG. 6 is a sectional view showing the action of the trowel according to FIG. 4;

FIG. 7 is a top view of a trowel according to the present invention showing the handle rotating; and

FIG. 8 is a perspective view of a trowel according to the present invention fabricated with an alternative blade.

### DETAILED DESCRIPTION OF THE PREFERRED EMBODIMENT

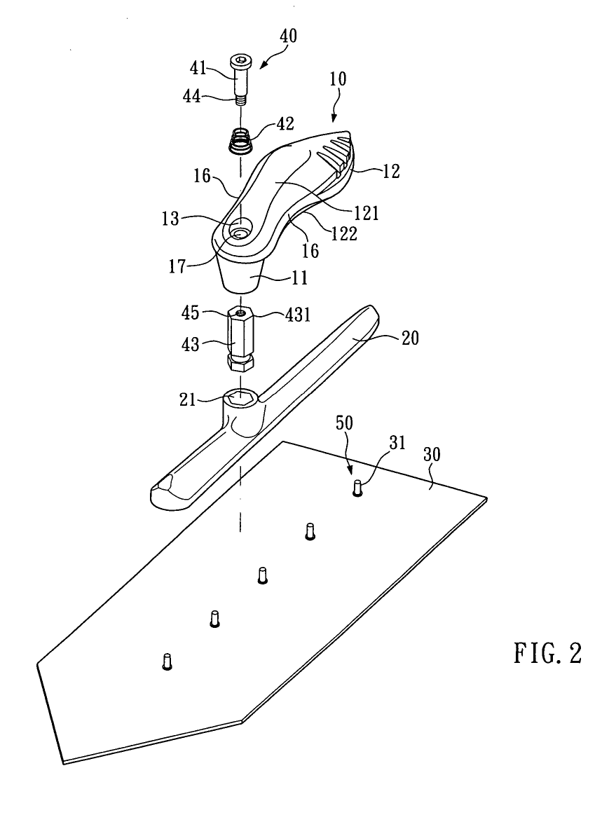

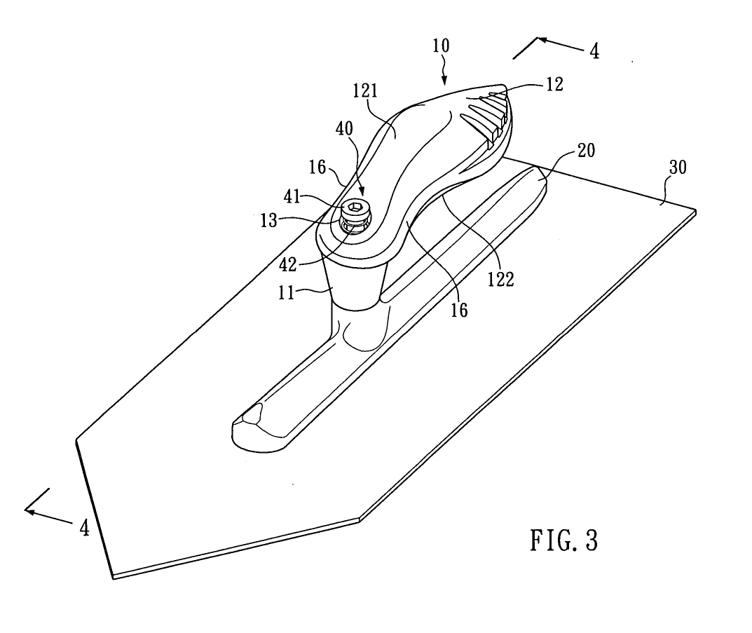

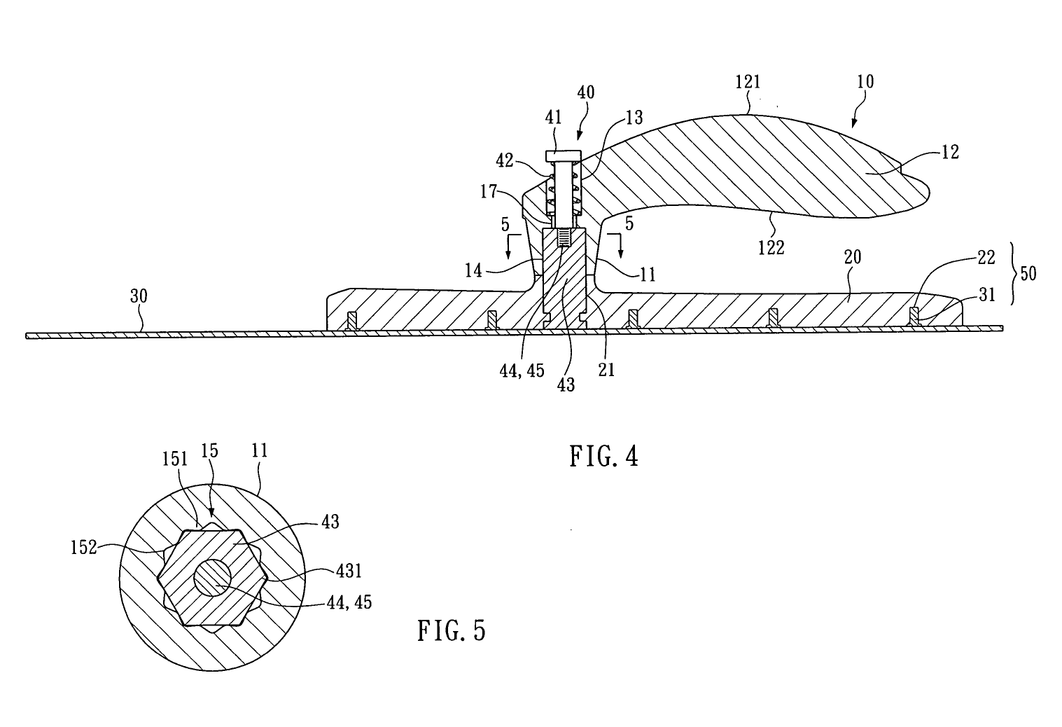

Please refer to FIGS. 2, 3 and 4. A trowel according to the present invention comprises:

a handle 10 which is one-piece formed composed by a connecting section 11 and a handling section 12; wherein, said handling section 12 has a substantially arched and parabolic upper surface 121 which makes the distance from upper surface 121 to lower surface 122, in other words, the thickness of the handling section 12 increased in the middle part correspondingly; wherein, each side edge of said handling section 12 has a center-forward arched indentation 16 disposed relatively near the connecting section 11; wherein, the connecting section 11 extends downward vertically against the handle 10 for a predetermined length with a shaft-tube appearance.

a tongue 20;

a blade 30;

a pivot structure 40 provided for connecting said tongue 20 to said connecting section 11 where allows the handle 10 being pivoted on the pivot structure 40 and positioned in a desired position ;in which, the pivot structure 40 further comprises a pressing component 41, a spring 42 and a prism 43; wherein, the spring 42 is placed outside the pressing component 41 which is arranged in an upward-open first bore 13; the pressing component 41 is properly sticking out the first bore 13 because of the elastic force of the spring 42 acting thereon; and the prism 43 is disposed in a downward-open second bore 14 of the connecting section 11; further, a retaining device 15 composed by a plurality of salients 151 formed along the wall of the second bore 14 in a circle. It should be noted that, as shown in FIG. 5, the inner diameter of the hole defined by the salients 151 precisely accommodates the prism 43, and an included angle 152 defined by each pair of adjacent salients 151 is provided to accommodate the vertex angle 431 of the prism 43; whereupon, the retaining device 15 can limit the prism 43 from pivoting. Besides, the first and second bores 13, 14 are communicated by a through hole 17 which has a relatively smaller diameter, where a threaded segment 44 formed at the bottom of the pressing component 41 can pass through and be screwed in a threaded bore 45 of the prism 43 to create a structural relationship between the pressing component 41 and prism 43. Furthermore, the bottom of the prism 43 is fixed in the handle-connecting hole 21 of the tongue 20; and,

a blade-fixing structure 50 comprising a plurality of blade-connecting hole 22 and a plurality of corresponding columns 31 on the blade 30. In one embodiment of the present invention, the tongue 20 is made of plastic material; therefore the blade-connecting holes 22 are slightly expandable in the diameter such that the columns 31 of the blade 30 made of metal can be lodged and retained in the blade-connecting hole 22; alternatively, the columns 31 can be unloaded from the blade-connecting hole 22 when the user sets pulling force thereon.

The first feature of a trowel according to the present invention is that the handle 10 can be rotated around; the second feature is that the blade 30 can be replaced to meet different working need. It is the third feature that the handle 10 is improved in handling comfortability and stability.

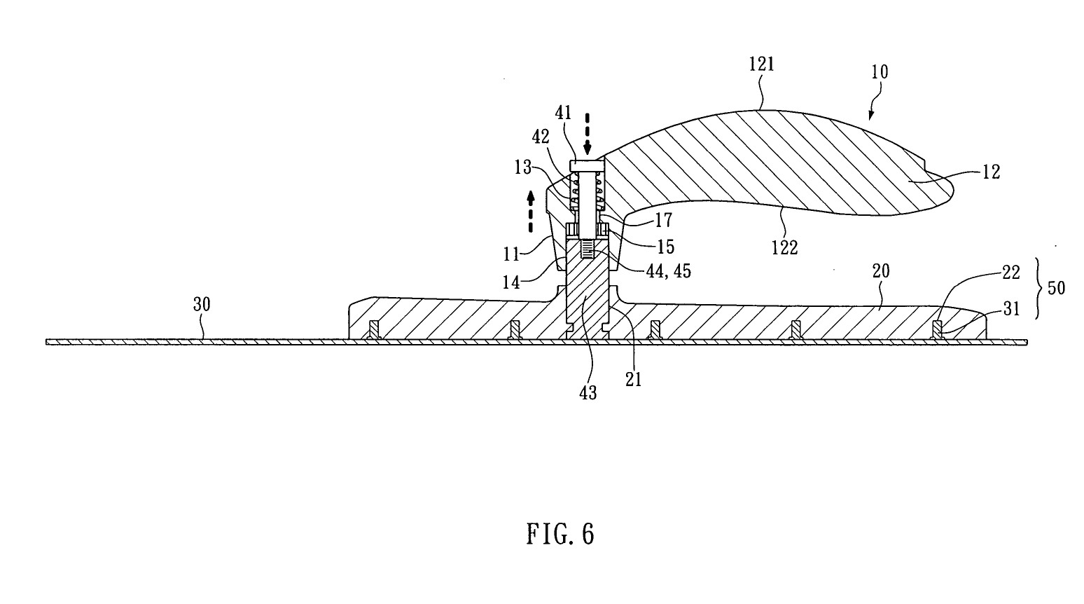

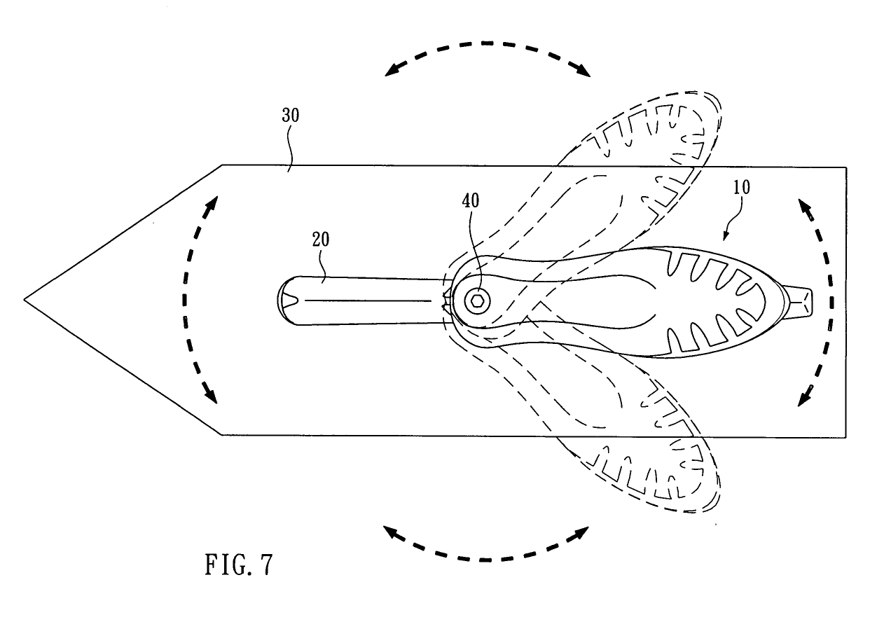

Please refer to FIG. 6. The feature of the handle of being rotatable is achieved by following means. A user places the trowel against a working surface and presses down the pressing component 41 to make the handle 10 lifted following a revise displacement and the retaining device 15 of the second bore 14 deviates the prism 43 in turn. At that point, the second bore 14 and prism 43 can respectively rotate freely. Therefore, a user can pivot the handle 10 on the pivot structure 40 to a desired position, as shown in FIG. 7. When the handle 10 arrives at a desired position, the user then releases the pressing component 41 to make the handle 10 returns. Thus, the prism 43 is inserted in the retaining device 15 and the vertex angles 431 of the prism 43 correspondingly lodge into the included angles 152 of the retaining device 15. While the retaining device 15 restricts the prism 43 from rotating, the handle 10 is capable of directing the blade. This feature allows a user to operate the trowel at will no. No matter how the working surface presents, a user can maintain comfortable holding and operating gesture by adjusting the position of the handle.

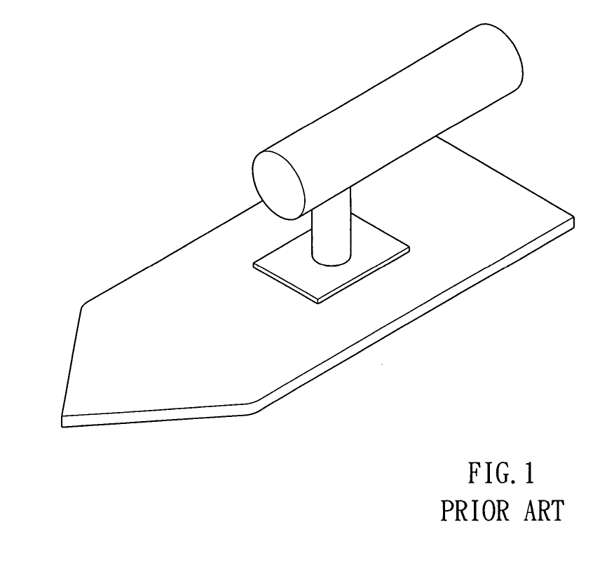

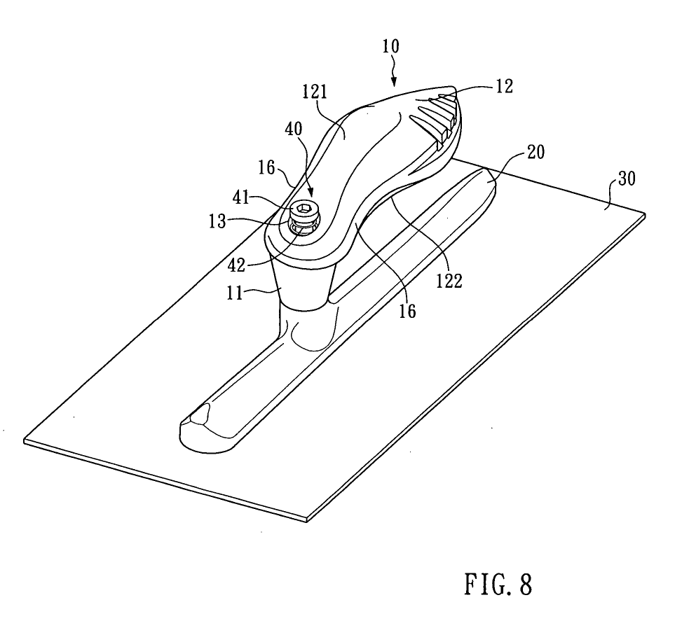

The feature of the blade 30 according to the present invention with replaceability is achieved by the blade-fixing structure as shown in FIG. 1 and FIG. 8. Since the blade 30 is attached to the tongue 20 by a plurality of columns 31 being inserted and retained in corresponding blade-connecting holes 22 of the tongue 20, the blade-connecting holes 22 and columns 31 can be separated when a user set force thereon. Thereby, a user can replace various blades 30 depending on different working surfaces. Further, the inconvenience about carrying and storing of current trowels is eliminated because merely one handle 10 is sufficient for operating various blades 30.

The feature of the handle 10 according to the present invention with improved comfortability and stability is generally achieved by the arched and parabolic upper surface 121 of the handling section 12. The designed thickness and width of the construction extends the contact area with a user's hand. Further, the anti-slip surface prevents the handle 10 from slippery. Moreover, the arch indentations 16 provided at right and left sides of said handle 10 allow the user's forefinger and thumb clamping the handle 10 with relatively less energy during operating. The ergonomic design improves the comfortability and stability for handling.

Although a particular embodiment of the invention has been described in detail for purposes of illustration, it will be understood by one of ordinary skill in the art that numerous variations will be possible to the disclosed embodiments without going outside the scope of the invention as disclosed in the claims. Accordingly, the invention is not to be limited except as by the appended claims.

What the invention claimed is:

1. A trowel which comprises:
a handle which is composed by a connecting section and a handling section as an integer;
a tongue which is attached at the bottom of the connecting section of the handle;
a blade which is disposed at the bottom of the tongue.
a pivot structure which is provided to combine said tongue and said connecting section such that the handle can be pivoted thereon and positioned at a desired position.

2. The trowel as claimed in claim 1, wherein, the pivot structure comprises a pressing component, a spring and a prism; wherein, the spring is placed outside the pressing component which is disposed in an upward-open first bore of the connecting section of the handle and the prism is arranged in a downward-open second bore of the connecting section of the handle; wherein, the first bore and second bore are connected; wherein, a structural relationship exists between the pressing component and the prism; wherein a retaining device is provided around the wall of the second bore to accommodate one end of the prism and prevent the prism from rotating; wherein, the bottom of the prism is fixed in a handle-connecting hole of the tongue.

3. The trowel as claimed in claim 2, wherein, the retaining device is composed by a plurality of salients formed along the wall of the second bore in a circle; wherein the diameter of the hole defined by said salients is accommodative to one end of the prism and an included angle defined by each pair of adjacent salients is accommodative to one of the vertex angles of the prism.

4. The trowel as claimed in claim 2, wherein, a threaded segment is formed at the lower end of the pressing component and screwed in a threaded bore at the end of the prism to create a structural relationship between said pressing component and said prism.

5. The trowel as claimed in claim 1, further comprises a blade-fixing structure for attaching said blade at the bottom of the tongue.

6. The trowel as claimed in claim 5, wherein, the blade-fixing structure comprises a plurality of blade-connecting holes provided at the lower surface of the tongue and a plurality of columns disposed on the blade.

7. The trowel as claimed in claim 1, wherein, the handling section of the handle comprises an arched and parabolic upper surface.

8. The trowel as claimed in claim 7, wherein, each side of said handling section has a center-forward arched indentation disposed relatively near said connecting section.
